(19) United States
(12) Patent Application Publication
(10) Pub. No.: US 2007/0039294 A1
(43) Pub. Date: Feb. 22, 2007

(54) Dual filtration lateral flow containment enclosure

(76) Inventor: Thomas Dean Airey, Winnipeg (CA)

Correspondence Address: ADE & COMPANY INC., 2157 Henderson Highway, WINNIPEG, MB, R2G1P9, CA

(21) Appl. No.: 11/428,007

(22) Filed: Jun. 30, 2006

Related U.S. Application Data
(60) Provisional application No. 60/695,449, filed on Jul. 1, 2005.
(60) Provisional application No. 60/719,220, filed on Sep. 22, 2005.

(51) Int. Cl. B01D 50/00

(52) U.S. Cl. 55/385.2

(57) ABSTRACT

A dual filtration lateral flow containment enclosure is described wherein an air evacuation system is used to provide negative airflow between an upstream filtration system and a downstream filtration system. The enclosure may be arranged such that there is no unfiltered venting between the environment and the interior of the enclosure if so desired. Furthermore, the filtration systems are arranged for the insertion of multiple types of filters, for example, HEPA filters, chemical filters, biological filters and the like for specific removal of air-borne materials from the air flow.

### PRIOR APPLICATION INFORMATION

This application claims the benefit of U.S. Provisional Patent Application 60/695,449, filed Jul. 1, 2005 and U.S. Provisional Patent Application 60/719,220, filed Sep. 22, 2005.

### FIELD OF THE INVENTION

This invention pertains to the field of hazardous materials containment systems and workspaces, and to the field of enhancing dispersed rapid response capacities to hazardous materials incidents (including the transport, treatment, and quarantine of material and casualties of hazardous materials incidents). The invention may be adapted for use with biological, chemical, toxicological, and radioactive materials

### BACKGROUND OF THE INVENTION

The present invention maintains its containment and product protection capacities even if its power or air handling systems fail. Traditional fume hoods, class I and class II biological safety cabinets (BSCs), and current lateral airflow designs that are adaptations of such BSCs rely upon airflow to provide hazard containment, having at least one unfiltered direct link to the environment that is utilized as an air make-up vent and/or an access portal. If airflow fails for any reason, hazardous material containment is breached as the enclosure becomes open to the environment (compromising personnel, product, and environmental protection). Even under normal operating conditions, high volumes of unfiltered, contaminated air continuously enter the enclosure and compromise product protection. Of even greater concern is the fact that the enclosure does not provide complete containment of hazardous materials. Any disruption in the airflow due to the movement of a worker's hands, equipment obstruction, heat currents, room air currents, and the like can cause small amounts of the air inside of the enclosure to escape containment. The present invention does not have an unfiltered link to the outside of the enclosure, nor does it have an unfiltered air make-up port, making sealing the unit for decontamination much easier.

Secondly, the present invention provides optimal direct, non-turbulent, laminar airflow without the ducting of airflow that traditional BSCs and current lateral airflow adaptations of traditional BSCs have. Unnecessary ducting and recirculating of airflow increases energy consumption, manufacture costs and complexity, space requirements, difficulty in maintenance and decontamination, and increases noise production.

Further descriptions and examples of the previous art can be found in U.S. Pat. No. 6,896,712 and the references cited therein.

### SUMMARY OF THE INVENTION

The present invention comprises an enclosed box of any suitable dimension. In a preferred embodiment, the enclosed box or enclosure further comprises two open opposing ends, an upstream end and a downstream end, that are each sealed with a custom arrangement of filters. This custom arrangement may consist of a single filtration device, or a combination of filtration devices with capacities that are selected to provide the required product protection and hazardous material containment. As discussed below, air enters the enclosure through the upstream end and flows through the enclosure to the downstream end where it is exhausted out of the enclosure.

The upstream end of the enclosure is sealed with one or more of the different filtration device options, as discussed below. The main functions of the upstream filter(s) are twofold:

1) To provide product protection by preventing contaminants in the ambient air from entering the enclosure. In many cases contaminants such as bacteria, mold spores, dust, environmental pollutants, etc. will interfere with the sample or with the protocol being undertaken and must be prevented from entering the enclosure.

2) To provide a secondary level of containment and personnel protection by preventing any hazardous material from escaping through the upstream end of the enclosure. It should be noted that this secondary level of containment is maintained even if the airflow or power systems are compromised in some manner. This is a very important safety feature that is not found on other such enclosures.

In a preferred embodiment, each of these filtration systems make up entire opposing end walls that may be parallel to each other and may be perpendicular to the lateral airflow. In alternative embodiments, each filtration system may comprise of only part of any wall or have any arrangement that produces lateral airflow through at least part of the workspace. Having the entirety of the airflow enter and exit the enclosure in this highly efficient manner provides the enclosure with constant and ideal laminar, and non-turbulent airflow. This feature also allows the enclosure to have the functionality of a fume hood.

According to the invention, there is provided a containment device comprising:

(a) an enclosure having a front wall, a back wall, a top wall, a bottom wall, an upstream end wall and a downstream end wall, said walls defining a chamber;

(b) an upstream air filtration system operably linked to the upstream end wall for passage of air therethrough and into the chamber;

(c) a downstream air filtration system operably linked to the downstream end wall for passage of air therethrough and out of the chamber;

(d) an air evacuation system to direct air along a horizontal path through said chamber from the upstream end wall to the downstream end wall, said air being in laminar flow within the chamber.

Thus, there is provided a workstation, robotic enclosure, workspace, room, or hazardous materials enclosure comprising a fully enclosed box of practically any dimension. Ideally, but not limited to, a top, two sides, a bottom, and two or more open opposing ends whose openings are each sealed with an arrangement of filtration devices.

There is also provided the ability for accommodating custom arrangements of filters that are sealed into the two or more “open” opposing ends of the enclosure that filter and scrub contaminants and hazardous materials from the air that passes through them. These filtration arrangements are ideally oriented parallel to each other and perpendicular to the lateral flow of air. These arrangements ideally make up the entire end wall(s) of the enclosure. These arrangements may consist of a single layer, a combination “sandwich” of multiple filter layers, or a hybrid combination layer of filtration devices that are selected to provide the required product protection and/or hazardous material containment. For example: When working with infectious material the current standard of filtration is a laboratory grade HEPA filter (high efficiency particulate air). If no chemical hazard exists the HEPA filter may be situated alone. If a chemical hazard exists along side a biological hazard the HEPA filter is located on the side of the filtration sandwiches that face the interior of the enclosure, with the appropriate chemical filter facing the outside of the enclosure. Similarly, if no biological or particulate hazard exists, a HEPA filter need not be used at the downstream end of the enclosure.

As discussed herein, there is also provided means of producing non-turbulent laminar airflow along a lateral and horizontal pathway through at least part of the enclosure. This lateral airflow is ideally produced by a fanbox or an active in-house air handling system connected to one of the filter arrangements in one of the opposing ends of the enclosure.

There may be one or more openings in the enclosure, and the opening(s) may or may not necessarily comprise an entire end wall, that are sealed with a filter or arrangement of filters as described above.

The openings may or may not be located in opposing walls.

At least one of the walls may comprise at least one access opening, and/or at least one glovebox style hazardous materials glove system to manipulate items within the enclosure.

The workstation, robotic enclosure, workspace, room, or hazardous materials enclosure described herein may be adaptable or connectable to a pass-through box for the safe addition and removal of material. Pass through boxes are typical of containment facilities and may be found in some specialized enclosures.

The filtration system may have an optional HEPA prefilter (ideally on the external side of a filtered air intake opening) to filter out ambient dust and/or to extend the life of the filtration arrangement.

Preferably, the workstation, robotic enclosure, workspace, room, or hazardous materials enclosure exhausts up to 100% of its airflow to the outside of the enclosure, thus preventing the build-up of chemical fumes and other hazardous materials. Exhausting up to 100% of the airflow enables the enclosure to double as a fume hood if it is vented to the outside. If the enclosure is fitted with a custom sandwich of filtration devices that scrub the specific chemical type from the air exhaust, the air exhaust may be vented to the room. This feature provides a fume hood capacity where one would not otherwise exist, and/or saves the cost and space of purchasing and installing a separate fume hood.

Preferably, the workstation, robotic enclosure, workspace, room, or hazardous materials enclosure is arranged to be adapted for emergency response to a chemical, biological, or nuclear/radiological incident. Such an adapted enclosure may be made of strong light weight materials, be collapsible and portable, have an ambulance type gurney with foldable wheels and handles, have an air handling system that was capable of being battery and/or solar powered with hook ups to a vehicle, building, generator, or other such source of power.

The workstation, robotic enclosure, workspace, room, or hazardous materials enclosure may utilize a filtration system or filtration options, other than just HEPA type filtration alone, that allows for the customization of the filtration capacities of said enclosure. This includes the utilization of filtration systems similar to those used in hazardous material respirators on such devices. This holds true whether they are used as: single filters, in combination with other filters in sandwiches, or as prepackaged combination hybrids of filters. This includes the use of these chemical filters alone or in combination with HEPA filters, to scrub hazardous chemicals, biological hazards, and particulates from the airflow and to provide a containment barrier to the same hazardous materials.

The fanbox may be in direct serial line with the airflow. This arrangement produces the most efficient, non-turbulent, laminar lateral airflow possible without the requirement for the redirection or balancing of airflow.

One or more of the device's ends or panels may be covered in whole or in part with one or more seal-able doors or removable caps whose function is to further seal off the enclosure for decontamination, storage, transportation, or to protect the filters and/or the internal environment of the enclosure when not in use.

Preferably, building materials for the device are selected so as to provide some shielding from radioactivity when working with radioactive materials and/or reagents.

In some embodiments, the workstation, robotic enclosure, workspace, room, or hazardous materials enclosure may be adapted or may simply be turned with either it's upstream side facing down, or on it's downstream side facing down to provide vertical laminar airflow (airflow in a downwards direction or in an upwards direction respectively). In this embodiment, the device further comprises legs or another form of support to hold the enclosure above the surface that it is placed upon.

The optimized design and non-recirculating lateral arrangement of the airflow discussed above, and the optimized non-recirculating vertical arrangement of the airflow discussed above, allows the enclosure to maintain product protection and containment capacities even when the power or air handling systems fail. This is accomplished by not having any unnecessary ducting and/or unfiltered open portals to the environment. Such ducting and openings exist in traditional BSCs and in lateral airflow adaptations of traditional BSCs and produce serious safety deficiencies.

The customizable arrangement and makeup of filtration sandwiches for various containment and air purification applications such as a workstation, robotic enclosure, workspace, room, or hazardous materials enclosures includes the use of filtration systems similar to those used in hazardous material respirators on such devices. This holds true whether they are used: as a single filter, in combination with other chemical or HEPA filters in sandwiches, or as prepackaged combinations or hybrid sandwiches of filters. This includes the use of these filtration systems to scrub hazardous chemicals and/or particulates from the airflow and/or to provide a containment barrier to hazardous materials.

The fully filtered, enclosed, and non-recirculating dual filtration airflow concept and arrangement of filtration systems in an enclosure may have a single filter or a customized sandwich of filtration devices in an enclosure to scrub the incoming airflow, and a separate filtration system to scrub the exhausting airflow of hazardous materials. This can occur at any opening, or in multiple openings in a workstation, robotic enclosure, workspace, room, or hazardous materials enclosure.

In some embodiments, the workstation, robotic enclosure, workspace, room, or hazardous materials enclosure has a large removable and resealable front access panel for the installation and removal of instrumentation and materials, as discussed herein.

### BRIEF DESCRIPTION OF THE DRAWINGS

FIG. 1: Longitudinal cross section of preferred embodiment of the invention with direct exhaust to the room.

FIG. 2: External front view of preferred embodiment of the invention with direct exhaust to the room.

FIG. 3: Longitudinal cross section of a second embodiment of the invention with external exhaust.

FIG. 4: External Front View of a second embodiment of the invention with external exhaust.

FIG. 5: Longitudinal cross section of a third embodiment of the invention with space saving option of having the fan box on top.

FIG. 6: External Front View of a third embodiment of the invention with space saving option of having the fan box on top.

FIG. 7: Longitudinal cross section of a fourth embodiment of the invention utilizing an active in house air handling system to produce lateral airflow.

FIG. 8: External Front View of a fourth embodiment of the invention utilizing an active in house air handling system to produce lateral airflow.

FIG. 9: Longitudinal cross section of a fifth embodiment of the invention adapted for emergency response.

FIG. 10: External front view of a fifth embodiment of the invention adapted for emergency response.

FIG. 11: Cross section of a fifth embodiment of the invention adapted for emergency response.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

When working with hazardous materials, institutions (such as laboratories, hospitals, and government agencies) must provide protection for their personnel, the environment, and often for the products that they are working with. The invention described herein is a containment solution for the safe manipulation of hazardous materials. This invention was specifically created to meet the need for an enclosure that efficiently provides the highest possible levels of personnel, product, and environmental protection in a highly adaptable arrangement. Whether you require containment for a biological, chemical, toxicological, or radioactive hazard (or if your hazard in unknown or a combination of these hazards), this enclosure can be fitted to provide containment, flexibility, and utility. This flexibility and breadth of scope can be accomplished through the simple addition of specialized filters, or a combination of filtration options. For example: where both biological and chemical containment are required, but exhausting to the outside is not possible or too expensive, the enclosure can be arranged to include a HEPA filter for biological and particulate containment in combination with an organic vapors filter for organic solvent containment. The addition of a specific vapors filter enables the enclosure to function as a fume hood for that specific class of chemicals even if venting to the outside of the facility is not possible.

The non-turbulent laminar lateral airflow and containment capabilities of this enclosure are especially well suited to house robotics, and other large pieces of equipment. Large pieces of equipment redirect, and disrupt the airflow in containment enclosures and thus compromise containment and protection that relies on that directional airflow.

This invention is capable of playing a major role in emergency preparedness by inexpensively providing the dispersed, portable, and rapid response capacity that is required for the management of hazardous material incidents. This can be achieved in two ways: 1) by adapting the enclosure for the assessment, transport, quarantine, and decontamination of material or casualties of hazardous material incidents; and 2) to provide dispersed capacity where none could otherwise exist by substituting this inexpensive enclosure for the building, operating, and maintenance of the thousands of local containment facilities that are required.

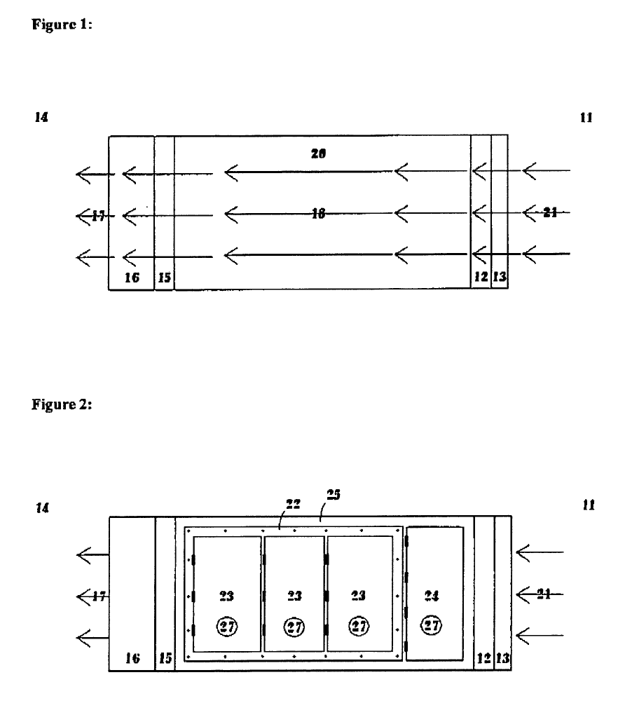

As discussed below, an air evacuation system, for example, a fanbox or an active in house air-handling system is used to evacuate air from the downstream end of the enclosure through the downstream air filtration system or sandwich (see FIGS. 1 through 11). Such evacuation produces negative air pressure inside of the enclosure relative to the ambient air pressure. This negative air pressure then draws air from the environment into the enclosure through the upstream filtration system in the opposite upstream end of the enclosure. This efficient arrangement produces dual filtered, non-turbulent, and laminar lateral airflow. As the lateral airflow travels from the upstream end to the downstream end, it sweeps or cleans or clears the interior of the enclosure of hazardous aerosols, particulates, and chemical fumes. Since the airflow is laminar and non-turbulent, it does not stir up contaminants and it does not produce eddies in the airflow that may retain contaminants.

The enclosure's primary containment capacities, as provided by the negative air pressure and its resulting lateral airflow, prevent any hazardous material from escaping the enclosure. If the physical barriers of the enclosure are compromised or if access doors must be opened to manually manipulate items in the workspace, the resulting inward airflow will maintain containment.

This enclosure has a secondary level of containment comprising physical barriers provided by the enclosure itself, its filtration systems, and its sealable access doors. If the primary containment system fails (due to power or air handling system failure) all hazardous materials are still contained. Since there are no unfiltered openings in this enclosure it is essentially a closed system to hazardous materials. Other systems that do not have this capacity would lose their containment and product protection capabilities during such a failure. This would leave personnel and the environment unprotected and exposed to hazardous materials during such a failure.

Depending on the application, the filter barriers may be comprised of or selected from laboratory grade HEPA filters for biological and particulate containment, chemical filtration/scrubbing systems for use with hazardous chemicals, or filters adapted for use with toxic, radioactive, or other hazardous materials. Combinations of the filter options provide multiple layers of protection and containment. A further option would be to add an inexpensive household grade filter (such as a common furnace type HEPA filter) to the upstream end ahead of the upstream laboratory grade HEPA filter. This prefilter would serve to filter out dust that may reduce the lifespan of the more expensive lab grade HEPA filter (and would reduce the amount of handling and replacement of the upstream HEPA filter that would be required).

When the airflow reaches the downstream end of the enclosure it is filtered through a second customized filter barrier, and then exhausted out of the enclosure. Depending upon requirements, regulations, and availability, the air may then be completely exhausted to the room or to the outside of the building.

An example of the invention's flexibility and capacity is a situation where you have to work with a combination of biohazardous and chemically hazardous materials. If environmental regulations permit, the chemical hazard can simply be vented to the outside of the building, as the downstream HEPA filter traps the biological hazard and prevents it from entering the exhaust. If exhausting to the outside is not possible, HEPA filters are used for biological and particulate containment, in combination with chemical vapor filters for chemical vapor containment. The addition of a specific vapors filter essentially enables the enclosure to function as a fume hood for that specific class of chemicals even if venting to the outside of the facility is not possible. This upstream filtration system would have two main parts: 1) a specific chemical filtration system on the outside, to prevent the escape of chemical fumes during an airflow failure, and 2) a HEPA filter for product protection and biohazard containment facing the inside of the enclosure. The downstream filtration arrangement would be similar with HEPA filtration for infectious and particulate hazards towards the inside of the enclosure, followed by a specific chemical filtration system on the outside to prevent the escape of hazardous chemical fumes. Once the chemical fumes have been removed from the airflow, the exhaust can be vented directly into the room.

All air traveling through the enclosure is completely exhausted and prevents hazardous chemicals from building up inside of the enclosure. This enables the enclosure to provide the capacity of a fume hood that can also be used with biohazardous materials. This useful feature is normally only found in two immobile types of BSCs that require hard ducting to the outside of the facility. These BSCs are the Class 2 type B3 BSCs that are not as fully contained and do not have the secondary level of containment that this invention has, and the Class 3 BSCs that do not have the level of access, efficiency, or portability of this invention.

Advantages of customizability, and efficiencies in terms of: aerodynamics, cost of manufacture, maintenance, and energy consumption are realized in this invention. Non-turbulent laminar lateral airflow is particularly advantageous given the size and aerodynamic profile of current laboratory equipment. Traditional BSCs are partially open to the environment and completely depend upon airflow for containment. Large equipment obstructs the airflow in traditional BSCs and compromises their existing containment capacity. Since BSCs cannot afford to lose any of their already incomplete containment or product protection, large pieces of equipment are best utilized in a dual filtration lateral airflow enclosure. Robotics, which often have an aerodynamic profile that is much lower from side to side than from front to back, are even more ideally suited to lateral airflow because they cause a minimum of airflow disturbance in laterally directed airflow.

Clear building materials, such as acrylic, provide high visibility for working with hazardous materials. Depending upon the decontamination strategies or solvents used, stainless steel and glass construction may be ideal (acrylic tends to crack and become opaque when exposed to certain solvents). Building materials that provide shielding from radioactivity when working with radioactive materials and/or reagents can also be utilized.

Through the use of: strong, lightweight materials; collapsible sides or plastic tenting for compactness; a battery powered air handling system; and the addition of ambulance style folding wheels or legs and stretcher handles, portable models for emergency response and fieldwork can be produced.

The flexibility of custom designing and arranging filter options, whether single filters or layers of different filter types, makes this enclosure highly adaptable to a vast array of applications. By using chemical filtration devices, such as those commonly available in cartridges for hazardous material respirators, this enclosure has even more applications. This allows the enclosure to be used as a fume hood where venting to the outside is either impossible, too expensive, or illegal. Chemical filtration devices also allow the enclosure to maintain chemical containment even if the power or air handling systems fail.

Additional versatility stems from the options that are available in producing and setting up this enclosure. The enclosure can be manufactured with many different overall sizes, placements and sizes of doors, access panels, air handling options, cable ports, glove box portals, pass through boxes, and many other existing technologies known to one of skill in the art.

In addition to having the advantages of accessibility, visibility, and customizability, this enclosure has many important safety and efficiency advantages as well. Most importantly this enclosure provides complete containment and protection regardless of the functional state of various subsystems. Containment is always maintained in spite of power outages, air system malfunction, and obstruction of airflow by equipment aerodynamics, and the like. The aerodynamic efficiency of this enclosure is due in part to the direct straight-through trajectory of the air flow with a lack of recirculation or ducting of exhaust back into the enclosure. This results in lower energy consumption, and less noise production. This is a simple design with easy manufacture, decontamination, and maintenance. Importantly, the air handling system (whether it is a fan box, an in house system, or other) is protected from contamination by the downstream filter system. This makes it much easier and safer to use and maintain the air handling system. This simple design also provides for easy sealing of the unit for overall decontamination. The addition of optional end caps or doors to seal the filtered ends for decontamination, storage, transport, and for protection of the filter systems when not in use, makes this design even more versatile and easy to use.

FIGS. 1 and 2 show a preferred embodiment of the present invention wherein the basic structure of the enclosure comprises an airtight box of any suitable dimension. It is of note that in these embodiments, the opposing sides are parallel to one another but this is not necessarily a requirement of the invention.

As shown in FIG. 1, in a preferred embodiment, the enclosure comprises the enclosure described above and has two open opposing ends. The upstream end (11) is sealed with the upstream custom arrangement of filters (12). Air that is directly entering into the enclosure from the environment (as represented by arrows designated 21) is filtered through the upstream filter(s) before entering the interior of the enclosure (20). The downstream end (14) is sealed with the downstream custom arrangement of filters (15) that removes hazardous materials from the air before it is exhausted from the enclosure (as represented by arrows designated 17) to the room. These filtration arrangements may be positioned perpendicular to the lateral airflow and may comprise a single filtration device, or a combination “sandwich” of filtration devices that are selected to provide the required product protection and hazardous material containment. The upstream filter (12) may have an optional prefilter (13) on its external side. This prefilter may be used to extend the life of the upstream filtration system by removing dust particles from the airflow before it plugs the more expensive lab grade HEPA or other type of filter. The fan-box (16) evacuates air from the enclosure through the downstream filtration device (15) to create a vacuum inside of the enclosure (20). This vacuum induces the lateral laminar airflow (as represented by arrows designated 18) inside of the enclosure (20).

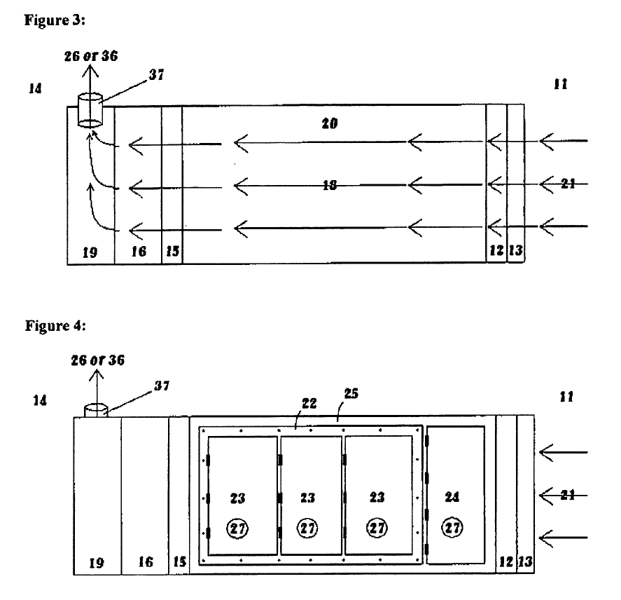

There are two approaches to dealing with hazardous chemicals in the airflow. If possible the chemical hazard(s) should be vented away from where they pose a hazard utilizing the second, third, or fourth embodiment of this invention (FIGS. 3 through 8). If it is not possible to simply vent the hazardous chemical to the outside, (due to regulations, expense, or infrastructural constraints) the chemical hazard must be removed from the airflow by the downstream custom arrangement of filters (15) before it is exhausted directly into the room (17). In this embodiment, the enclosure provides a fume hood type capacity in series with its particulate and biological containment capacities.

It is important to note that the present invention does not include aN unfiltered opening to the environment nor does it include a conduit for the recirculation, in part or in full, of exhausted airflow through the enclosure. By avoiding this, the present invention is more efficient and maintains its containment capacities regardless of the status of the air handling or power systems.

Referring to FIG. 2, from this perspective you can see an optional removable access panel (22) for the installation and maintenance of large pieces of equipment. This access panel may have one or more optional sealable, customizable, and ideally hinged access doors (23). Other access doors (24) need not be located in the access panel and can be installed in the front panel (25) or another panel. The access doors may have optional sealable glove box portals (27) for improved access and manipulation of highly hazardous materials using glove box style containment gloves (30), as shown in FIG. 11.

Referring to FIG. 3, in an embodiment wherein the air cannot be exhausted directly to the room, the exhaust is vented to the outside via an airflow adaptor (19; FIGS. 3 through 8). This airflow adaptor connects the enclosure to a passive (26) or an active (36) in house air handling system. An active air handling system is one that provides part or all of the air movement. A passive air handling system is one that simply provides a route for the airflow to exhaust through to the outside. As shown in FIG. 3, in this embodiment, the air passes through the downstream filtration system (15) and the fanbox (16) before it is exhausted to the outside via an airflow adaptor (19). This airflow adaptor (19) connects and guides the airflow exhaust from the enclosure, out through an exhaust port or duct (37). This exhaust port connects to a passive (26), or to an active (36) in house air handling system that removes the exhaust to the outside of the building.

Referring to FIG. 4, in this embodiment, the air is exhausted to the outside either through a passive (26) or an active (36) in house air handling system.

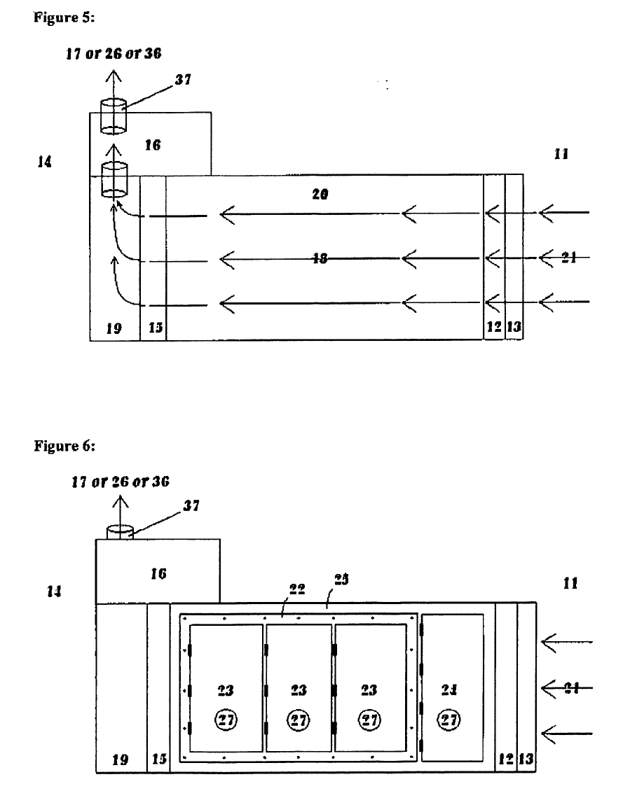

Referring to FIG. 5, in this embodiment, as a lateral space saving option, the fanbox (16) may be situated on top of the enclosure. After the filtered air exhaust passes through the fanbox it may be vented through an exhaust port or duct (37) to the room (17), or it may be vented through a passive (26) or an active (36) in house air handling system.

Referring to FIG. 6, in this embodiment, the fanbox (16) is located on top of the enclosure to keep the width of the enclosure down to a minimum.

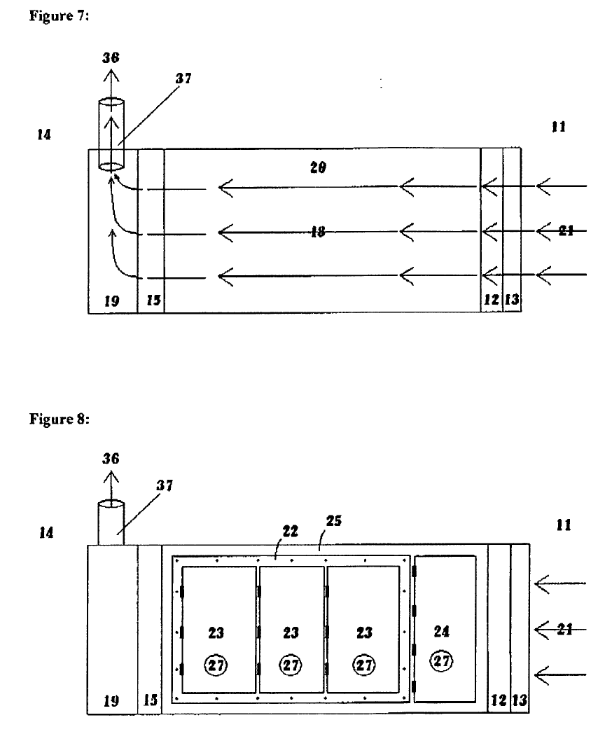

Referring to FIG. 7, in this embodiment, where available, an active in house air handling system (36) may be used to evacuate air {through an exhaust port or duct (37)} from the airflow adaptor (19) to create a vacuum. This vacuum in turn draws air from the enclosure through the downstream filtration device (15), and induces the desired negative air pressure and lateral laminar airflow (18 represented by arrows) inside of the workspace (20). It is of note that in these embodiments, the fanbox (16) is not required.

Referring to FIG. 8, in this figure air is exhausted to the outside through an active in house air handling system (36).

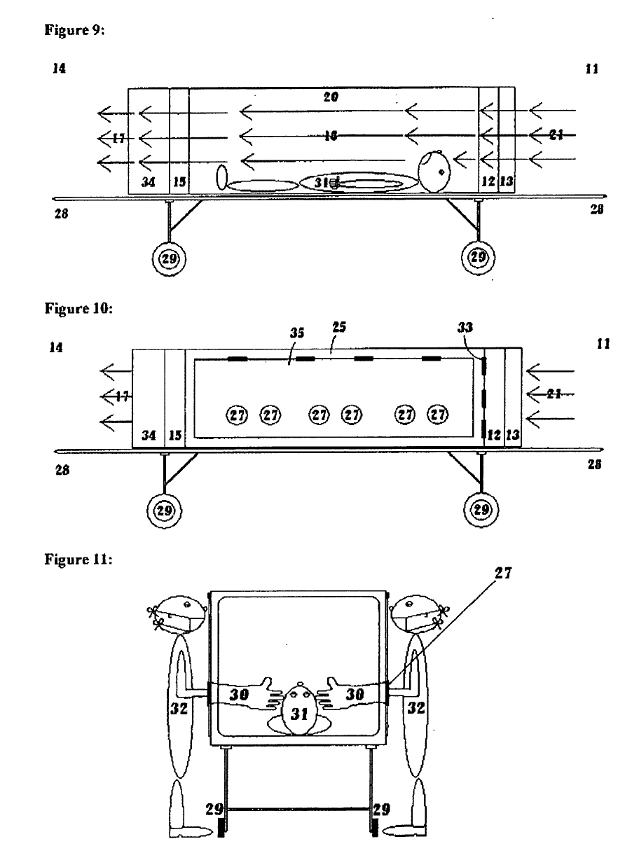

Referring to FIG. 9, in this embodiment, there is provided an emergency response embodiment which further comprises a number of features that adapt it to for use in emergency response. Many features such as the use of lightweight and strong composite materials, collapsible sides for compactness in shipping, battery and/or solar powered air handling system (34), an ambulance-style gurney with retractable stretcher handles (28), and folding wheels (29) can be added to the enclosure to produce portable models for emergency response and fieldwork.

Referring to FIG. 10, in this embodiment, there are provided optional sealable glove box style portals (27) which allow for the addition of glove box style containment gloves (#30: FIG. 11). One or more of the side panels (25) may have one or more hinged custom access doors of various sizes (35). One or more of the side panels (25) or access doors (35) may also have sealable glove box style portals (27) and/or additional hinged custom access doors (35).

One of the filtration systems, preferably the upstream system, may be hinged (33) on one side to allow materials, or casualties (#31; FIGS. 9 and 11) to be easily slid into, or (after decontamination) out of the enclosure on rollers via a stretcher. Alternatively, this hinged opening (33) may be adapted to attach to a pass-through box to allow for the transfer of materials in or out of the enclosure, or for the transfer of casualties to a hospital or laboratory quarantine facility.

Referring to FIG. 11, in this embodiment, there are provided optional sealable glove box style portals (27) which allow for the addition of glove box style containment gloves (30). Glove box style containment gloves allow rescue workers, doctors, and researchers (32) superior access to safely assess, manipulate, decontaminate, and treat items and casualties (31) in the interior of the enclosure.

While the preferred embodiments of the invention have been described above, it will be recognized and understood that various modifications may be made therein, and the appended claims are intended to cover all such modifications which may fall within the spirit and scope of the invention.

1. A containment device comprising:
(a) an enclosure having a front wall, a back wall, a top wall, a bottom wall, an upstream end wall and a downstream end wall, said walls defining a chamber;
(b) an upstream air filtration system operably linked to the upstream end wall for passage of air therethrough and into the chamber;
(c) a downstream air filtration system operably linked to the downstream end wall for passage of air therethrough and out of the chamber;
(d) an air evacuation system to direct air along a horizontal path through said chamber from the upstream end wall to the downstream end wall, said air being in laminar flow within the chamber.

2. The device according to claim 1 wherein the air evacuation system is a fanbox.

3. The device according to claim 1 wherein the air evacuation system is an in-house air system.

4. The device according to claim 1 wherein the enclosure further comprises at least one sealable access door.

5. The device according to claim 1 wherein the enclosure further comprises a removable access panel.

6. The device according to claim lwherein the enclosure further comprises a sealable glove box portal.

7. The device according to claim 1 wherein the upstream air filtration system includes a HEPA filter.

8. The device according to claim 1 wherein the downstream air filtration system includes a HEPA filter.

9. The device according to claim 1 wherein the downstream air filtration system includes an organic vapor filter.

10. The device according to claim 1 wherein the upstream air filtration system includes an organic vapor filter.
